(19) United States
(12) Patent Application Publication
(10) Pub. No.: US 2008/0317417 A1
(43) Pub. Date: Dec. 25, 2008

(54) Optical coupling module, optical connector, and fixing member

(75) Inventor: Jun Tamada, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/153,527

(22) Filed: May 20, 2008

(30) Foreign Application Priority Data
Jun. 22, 2007 (JP) 2007-165578

(51) Int. Cl. G02B 6/36

(52) U.S. Cl. 385/92; 385/88

(57) ABSTRACT

An optical coupling module attaches and detaches an optical fiber with respect to a device that carries out optical communication. The optical coupling module includes a sleeve that includes and couples the optical fiber, a sleeve case that covers the sleeve, and a guiding unit that guides, an optical connector that is inserted from outside, such that an optical fiber, exposed at the tip of the optical connector, penetrates inside the sleeve. The guiding unit includes elastic members that are deformed due to the optical connector being inserted and fix the optical connector.

### BACKGROUND OF THE INVENTION

1. Field of the Invention

The present invention relates to an optical coupling module, an optical connector, and a fixing member that are used for optical communication, and, more particularly to an optical coupling module, an optical connector, and a fixing member that enable to control an optical loss by improving degradation of a wiggle characteristic upon addition of an external force and enable to enhance optical communication quality.

2. Description of the Related Art

Generally, a device, which performs optical communication, includes an optical coupling module that includes a function to transceive signals between devices. In recent times, a pluggable structure of such optical coupling modules has become standard and the optical coupling modules are directly connected to optical connectors provided on a front panel of the device. The optical coupling module couples external optical fibers with a light emitting element and a light receiving element inside the optical coupling module. Further, the optical coupling module includes a function, which converts into electronic signals, optical signals that are input from outside and converts into the optical signals, the electronic signals that are output from inside the device. In a technology disclosed in Japanese Patent Application Laid-open No. 2005-156969, for example, a junction structure of the external optical fibers and the optical coupling module includes a sleeve that fixes and couples the external optical fibers with a ferrule of the light emitting element and the light receiving element.

However, recently, compactness and high density of the optical coupling module are increasingly enhanced. Due to this, among the optical coupling modules that are mounted at a high density, when attaching or detaching the optical fibers or the optical coupling module itself from the device, a hand of a user is likely to touch the adjacent optical fibers, thus resulting in application of an external force. Application of the external force causes deformation of the sleeve inside the optical coupling module and causes an optical axis displacement, thus increasing an optical loss.

### SUMMARY OF THE INVENTION

It is an object of the present invention to at least partially solve the problems in the conventional technology.

According to an aspect of the present invention, an optical coupling module that attaches and detaches an optical fiber supported by an optical connector with respect to an optical communication device, includes a sleeve for receiving the optical fiber therein, a sleeve case for covering the sleeve, a guiding unit for guiding the optical connector such that the optical fiber, exposed at a tip of the optical connector, penetrates inside the sleeve when the optical connector is inserted from outside, and an elastic member, provided on the guiding unit and capable of being deformed, for fixing the optical connector when the optical connector is inserted into the guiding unit.

According to another aspect of the present invention, an optical connector that supports a first optical fiber and is guided by a guiding unit mounted on an optical coupling module that couples the first optical fiber, exposed at a tip of the optical connector, with a second optical fiber attached to the optical coupling module. The optical connector includes a fixing structure that is deformed and fixed to the guiding unit when the optical connector is inserted into the guiding unit.

According to still another aspect of the present invention, an optical coupling module that attaches and detaches an optical fiber supported by an optical connector with respect to an optical communication device, includes a sleeve for receiving the optical fiber therein, a sleeve case for covering the sleeve, and a fixing member for restricting movement of the optical connector that causes the optical fiber, exposed at a tip of the optical connector, to penetrate the sleeve.

According to still another aspect of the present invention, an auxiliary fixing member to be mounted on a substrate equipped with an optical coupling module that attaches an optical fiber supported by an optical connector with respect to the substrate, includes a housing unit that restricts movement of the optical connector that causes the optical fiber, exposed at a tip of the optical connector, to penetrate the optical coupling module, and a fixing unit that fixes the auxiliary fixing member to the substrate.

According to still another aspect of the present invention, an auxiliary fixing member to be mounted on an optical communication device equipped with an optical coupling module that attaches an optical fiber supported by an optical connector with respect to the optical communication device, includes a housing unit that restricts movement of the optical connector that causes the optical fiber, exposed at a tip of the optical connector, to penetrate the optical coupling module, and a fixing unit that fixes the auxiliary fixing member to the optical communication device.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of an optical coupling module according to a first embodiment of the present invention;

FIG. 2 is a schematic of a detailed structure of a guiding unit shown in FIG. 1;

FIG. 3 is a schematic of the guiding unit after the guiding unit is connected to an optical connector;

FIG. 4 is a schematic of inclination of a ferrule when an optical axis displacement width is zero;

FIG. 5 is a schematic of an optical connector according to a second embodiment of the present invention;

FIG. 6 is a schematic of a detailed structure of a mold unit according to the second embodiment;

FIG. 7 is a schematic of the mold unit after the mold unit is connected to the optical coupling module;

FIG. 8 is a schematic of an optical coupling module according to a third embodiment of the present invention;

FIG. 9 is a schematic of the optical coupling module after the optical connector is fixed;

FIG. 10 is a schematic of a fixing member that fixes a position of the optical connector that is connected to the optical coupling module that is mounted on a substrate;

FIG. 11 is a schematic of the optical coupling module after the optical connector is fixed;

FIG. 12 is a schematic of the fixing member that fixes the position of the optical connector that is connected to the optical coupling module that is mounted on a chassis of a device;

FIG. 13 is a schematic of an existing optical coupling module;

FIG. 14 is a schematic of the ferrule that is inserted into a sleeve and that is viewed from an insertion direction;

FIG. 15 is a schematic of an optical axis displacement;

FIG. 16 is a schematic of the ferrule that is displaced; and

FIG. 17 is a schematic of an example of a wiggle-characteristic measuring method.

### DETAILED DESCRIPTION OF THE PREFERRED EMBODIMENTS

Exemplary embodiments of the optical coupling module, the optical connector, and the fixing member according to the present invention are explained below with reference to the accompanying drawings.

An existing optical coupling module is explained below. FIG. 13 is a schematic of an existing optical coupling module 10. As shown in FIG. 13, the optical coupling module 10 includes a fiber stub 101, a sleeve 102, and a sleeve case 103. The sleeve 102 is a hollow cylinder that positions both ends of optical fibers. The sleeve case 103 protects the sleeve 102. The fiber stub 101 is a cylindrical member that retains the optical fiber and that is inserted in an opening or groove on the sleeve 102 from inside a device that carries out optical communication.

An optical connector 20, which is connected to the optical coupling module 10, includes a ferrule 201 and a mold unit 202. The ferrule 201 retains the optical fiber. The mold unit 202 is a member that an operator holds when attaching or removing the optical connector 20. When coupling the optical fiber of the optical connector 20 with the optical fiber of the optical coupling module 10, the ferrule 201 is inserted in the opening or groove on the sleeve 102 from outside the device that carries out optical communication. Upon inserting the ferrule 201, the sleeve 102 undergoes elastic deformation. Due to this, the ends of the optical fibers are coupled and coinciding of optical axes is maintained.

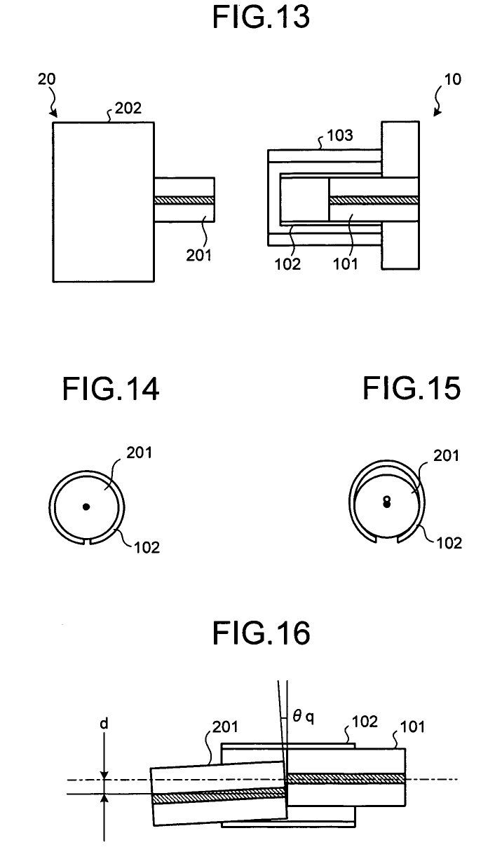

FIG. 14 is a schematic of the ferrule 201 that is inserted into the sleeve 102 and that is viewed from an insertion direction. As shown in FIG. 14, the sleeve 102 is a slit sleeve and a slit is formed along a longitudinal direction of the cylinder. The slit sleeve is often used in commonly used optical coupling modules. As shown in FIG. 14, normally the sleeve 102 and the ferrule 201 adhere firmly to each other, and the optical axis of the optical fiber that is retained by the ferrule 201 coincides with the optical axis of the optical fiber that is retained by the fiber stub 101 due to alignment effect of the sleeve 102.

However, in the existing optical coupling module 10, application of an external force to the connected optical connector 20 due to some reason results in occurrence of an optical axis displacement. FIG. 15 is a schematic of occurrence of the optical axis displacement. As shown in FIG. 15, because a retaining force of the sleeve 102 is weak, if the external force is applied to the optical connector 20, the slit opens wide, and the ferrule 201 is displaced in an application direction of the external force, thus resulting in the optical axis displacement.

FIG. 16 is a schematic of the displaced ferrule 201. As shown in FIG. 16, if the external force is applied in a perpendicularly downward direction and the ferrule 201 is displaced, an angle θq between an end surface of the ferrule 201 and an end surface of the fiber stub 101 increases (θq is an angle that occurs due to a difference between an inner diameter of the sleeve 102 and an outer diameter of the ferrule 201). Furthermore, upon application of a greater external force, the ferrule 201 moves in a perpendicularly downward direction and the optical axis is displaced by a distance d in a perpendicular direction.

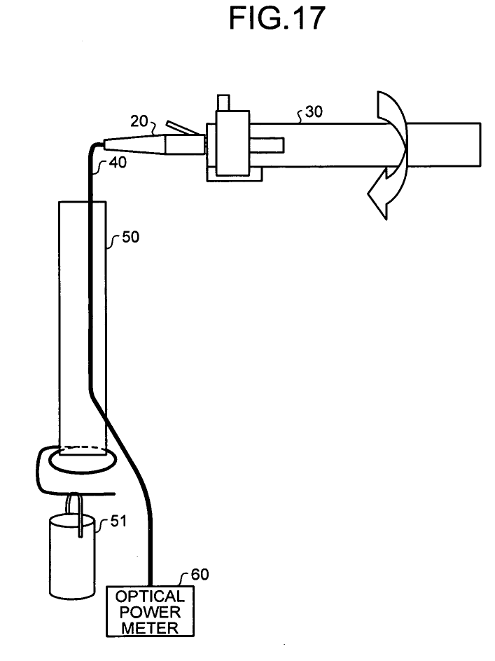

An optical loss variation characteristic, which occurs at the time of application of the external force to the optical connector and the optical fiber, is called a wiggle characteristic. FIG. 17 is a schematic of an example of a wiggle-characteristic measuring method. In the example shown in FIG. 17, an optical module 30, which includes the optical coupling module and a light emitting element is connected to the optical connector 20 and maintained horizontal with respect to the ground. An optical fiber 40, which extends from the optical connector 20, is mounted on a weight fixing structure 50. A weight 51 is attached to the weight fixing structure 50. The optical fiber 40 is stretched perpendicular to the ground, and connected to an optical power meter 60 that measures intensity of light.

Optical signals are transmitted from the optical module 30 towards the optical power meter 60 via the optical fiber 40 and a relation between a rotation angle and an optical loss variation is measured while rotating the optical connector 20 once to the left and once to the right. A measurement result is a value of the wiggle characteristic. Improvement of the wiggle characteristic is extremely significant for improving communication quality in optical communication.

If a target value of the wiggle characteristic is 1.5 decibels (dB), based on an analysis result of a Gaussian approximation model, an optical fiber transmission mode needs to be maintained such that an optical axis displacement width d is less than or equal to 2 micrometers (μm) (when θq is zero) and θq is less than or equal to 0.36 degrees (when d is zero). However, in the existing optical coupling module such as the optical coupling module 10, because the external force applied to the optical connector 20 is entirely borne by the sleeve 102, the retaining force that is necessary for attaining the target value mentioned earlier cannot be obtained.

An optical coupling module 11 according to a first embodiment of the present invention is explained below. In the optical coupling module 11 explained below, components, which are similar to the components already explained, are indicated by the same reference numerals and a detailed explanation of such components will not be repeated here.

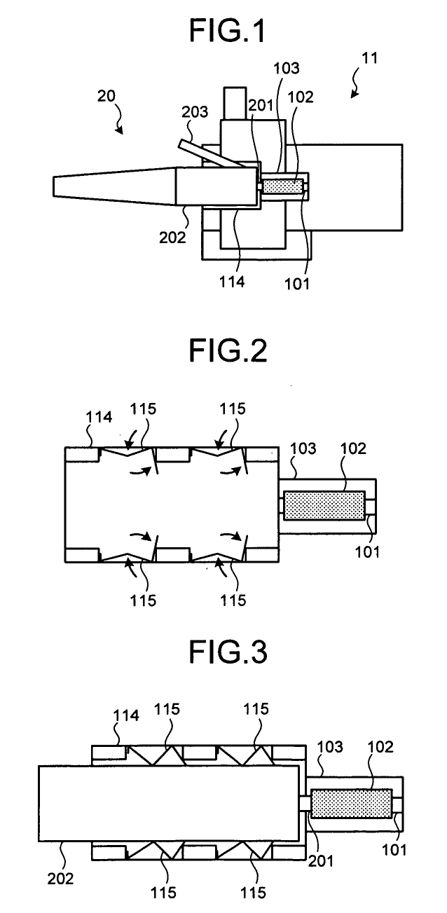

FIG. 1 is a schematic of the optical coupling module 11 according to the first embodiment. As shown in FIG. 1, the optical connector 20, which includes the ferrule 201, the mold unit 202, and a stopper 203, is connected to the optical coupling module 11. Further, as shown in FIG. 1, the optical coupling module 11 includes a guiding unit 114 in addition to the fiber stub 101, the sleeve 102, and the sleeve case 103.

The guiding unit 114 is a cylindrical member that guides the optical connector 20 such that the ferrule 201 of the optical connector 20 is inserted properly into the sleeve 102. Further, the guiding unit 114 retains the mold unit 202 of the connected optical connector 20 and reduces the effect of the external force. As shown in FIG. 2, the guiding unit 114 includes a plurality of elastic members 115 on an inner surface of the guiding unit 114. As shown in FIG. 3, if the optical connector 20 is inserted inside the guiding unit 114, the elastic members 115 undergo deformation due to the pressure exerted by the optical connector 20 and fix the mold unit 202 of the optical connector 20.

A mechanism of deformation of the elastic members 115 is not to be limited to the mechanism shown in FIGS. 2 and 3. Any mechanism can be used in which the elastic members 115 undergo deformation due to the pressure of the inserted optical connector 20 and fix the mold unit 202 of the optical connector 20.

Thus, if the external force is added to the optical connector 20, even if the ferrule 201 is marginally inclined, because the mold unit 202 of the optical connector 20 is fixed by the guiding unit 114, an increase in the optical axis displacement width d is prevented due to deformation of the sleeve 102. An effect of an inclination of the ferrule 201 upon addition of the external force to the optical connector 20 is explained.

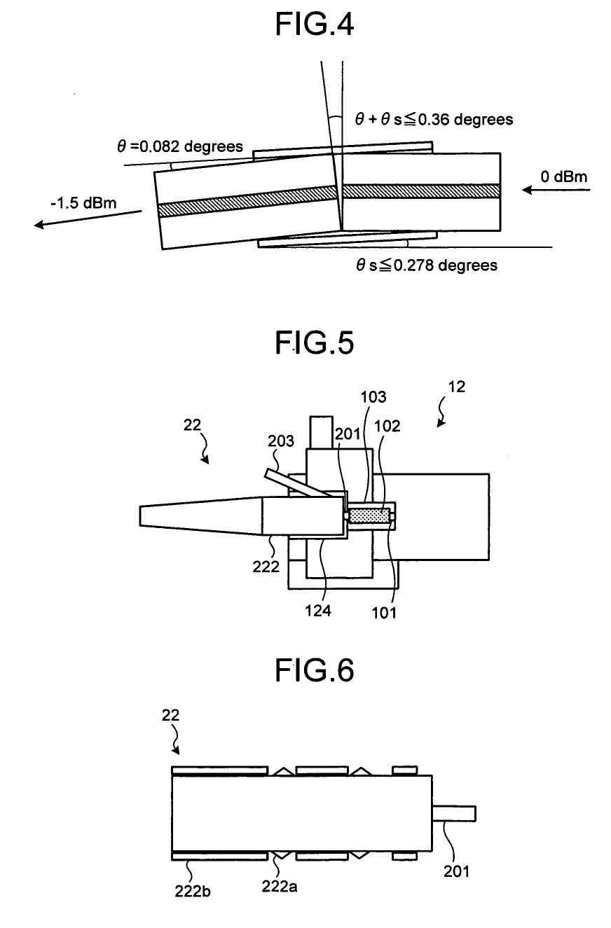

FIG. 4 is a schematic of an inclination of the ferrule 201 when the optical axis displacement width d is zero. A positional relation among the ferrule 201, the fiber stub 101, and the sleeve 102 when the external force is added in the perpendicularly downward direction is shown in FIG. 4. As shown in FIG. 4, an angle θ is an inclination angle (ferrule inclination angle) that occurs due to a difference between the inner diameter of the sleeve 102 and the outer diameter of the ferrule 201. An angle θs is an inclination angle (sleeve inclination angle) that occurs due to a difference between an outer diameter of the sleeve 102 and an inner diameter of the sleeve case 103.

When the optical axis displacement width d is zero, a maximum value of the angle θ is 0.082 degrees. If the target value of the wiggle characteristic is 1.5 dB, because a limiting value of θq=θ+θs is 0.36 degrees as mentioned earlier, the sleeve inclination angle θs needs to be curbed at less than or equal to 0.278 degrees (=0.36 degrees−0.082 degrees). As shown in FIG. 3, in addition to the sleeve 102 and the sleeve case 103, the optical coupling module 11 according to the first embodiment includes the guiding unit 114 that further includes the elastic members 115. Due to this structure, the wiggle characteristic can be enhanced to attain the angle θs mentioned earlier.

Thus, according to the first embodiment, when the optical connector 20 is inserted in the optical coupling module 11, the elastic members 115 included in the guiding unit 114 are caused to deform and the optical connector 20 is fixed in a predetermined position. Thus, collapsing of the sleeve 102 and jolting of the ferrule 201, which occur due to inclination of the optical fiber on the side of the optical connector 20 along with the optical connector 20, can be restricted and a position of coupling surfaces of the optical fibers can be retained according to an alignment function of the sleeve 102 even if the external force is applied.

Inclusion of the mechanism, which fixes a mold unit of the optical connector on the optical coupling module side, is explained in the first embodiment. However, a mechanism can be included in which the mold unit is fixed on the optical connector side. Inclusion of the mechanism, which fixes the mold unit on the optical connector side, is explained in a second embodiment of the present invention.

FIG. 5 is a schematic of an optical connector 22 according to the second embodiment. As shown in FIG. 5, the optical connector 22 is connected to an optical coupling module 12. In addition to the fiber stub 101, the sleeve 102, and the sleeve case 103, the optical coupling module 12 includes a guiding unit 124. The guiding unit 124 is a cylindrical member that guides the optical connector 22 such that the ferrule 201 of the optical connector 22 is inserted properly into the sleeve 102.

The optical connector 22 includes a mold unit 222 instead of the mold unit 202 that is included in the optical connector 20. As shown in FIG. 6, the mold unit 222 includes a mold base 222a and a sliding unit 222b. The sliding unit 222b is an elastic, cylindrical member. The sliding unit 222b is attached to the optical connector 22 such that the sliding unit 222b can slide over a surface of the mold base 222a. A plurality of openings are arranged on the sliding unit 222b and the mold base 222a includes projections that protrude from the brackets.

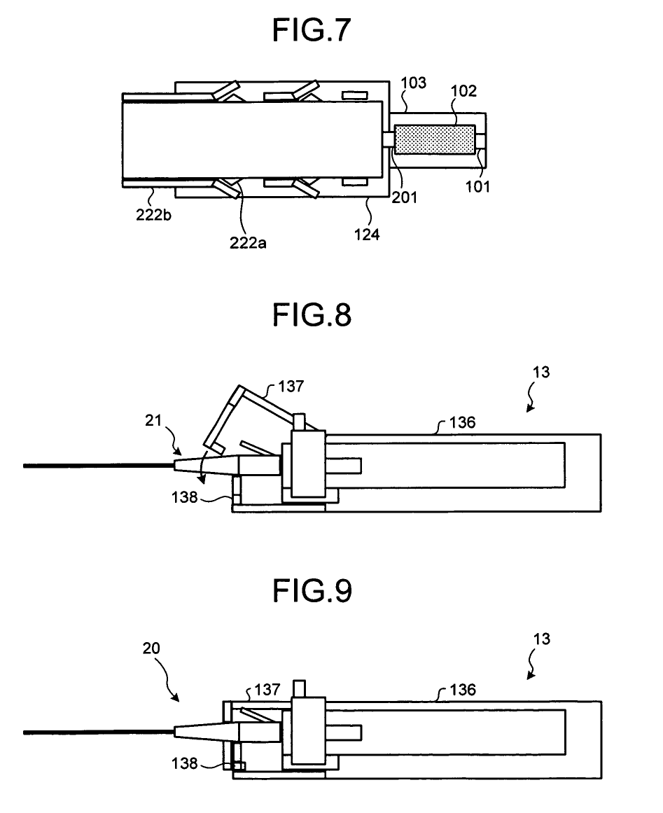

As shown in FIG. 7, after inserting the optical connector 22 into the optical coupling module 12, when the user causes the sliding unit 222b to slide, the sliding unit 222b is pressed by the projections of the mold base 222a, undergoes deformation, presses against the inner surface of the guiding unit 124, and fixes the optical connector 22 at the predetermined position inside the optical coupling module 12.

Thus, according to the second embodiment, the sliding unit 222b of the optical connector 22 is caused to slide, thus deforming the sliding unit 222b and fixing the optical connector 22 in the predetermined position. Thus, collapsing of the sleeve 102 and jolting of the ferrule 201, which occur due to inclination of the optical fiber on the side of the optical connector 22 along with the optical connector 22, can be restricted and the position of the coupling surfaces of the optical fibers can be retained according to the alignment function of the sleeve 102 even if the external force is applied.

Addition of a structure, which retains the optical connector in a cage that protects the optical coupling module, is explained in a third embodiment of the present invention. FIG. 8 is a schematic of an optical coupling module 13 according to the third embodiment. As shown in FIG. 8, the optical connector 21 (or 20 in FIG. 9) is connected to the optical coupling module 13. The optical coupling module 13 includes a cage 136 for protecting the optical coupling module 13 itself. Further, the cage 136 includes a fixing member 137 that retains the optical connector 21 (or 20 in FIG. 9) and a locking mechanism 138 for fixing the fixing member 137.

After connecting the optical connector 21 (or 20 in FIG. 9) to the optical coupling module 13, the fixing member 137 is moved such that the fixing member 137 covers the mold unit 202 of the optical connector 21 (or 20 in FIG. 9). Further, as shown in FIG. 9, the fixing member 137 is fixed by the locking mechanism 138 such that a movement of the optical connector 20 is restricted. Thus, the optical connector 20 is retained at the predetermined position and is less likely to be affected by the external force.

Thus, according to the third embodiment, the optical connector 20 is fixed at the predetermined position using the fixing member 137 that is included in the cage 136. Thus, collapsing of the sleeve 102 and jolting of the ferrule 201, which occur due to inclination of the optical fiber on the side of the optical connector 20 along with the optical connector 20, can be restricted and the position of the coupling surfaces of the optical fibers can be retained according to the alignment function of the sleeve 102 even if the external force is applied.

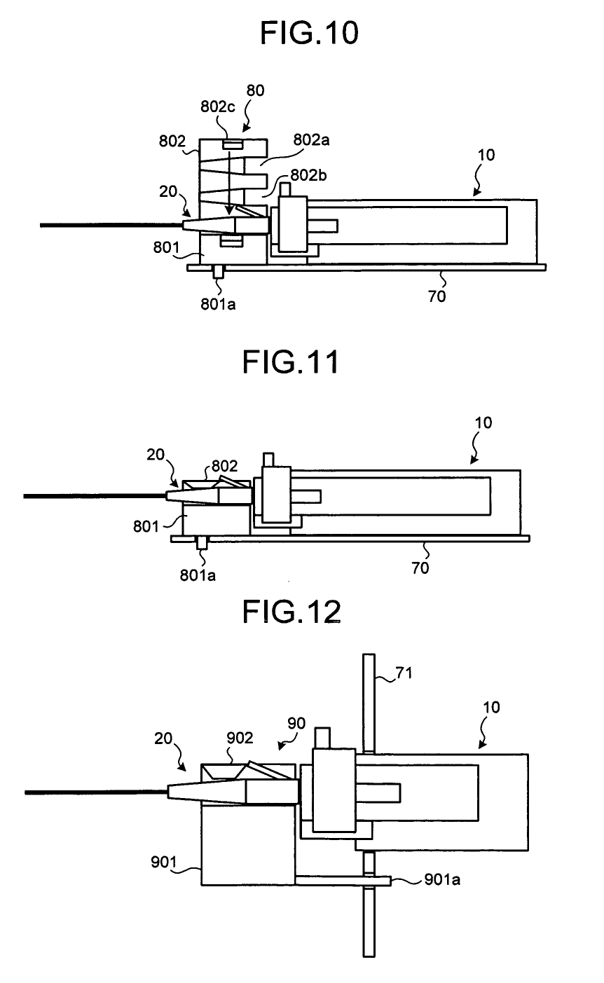

A member which fixes the mold unit 202 of the optical connector 20 in the predetermined position can also be separated from the optical coupling module. FIG. 10 is a schematic of a fixing member 80 which fixes the position of the optical connector 20 that is connected to the optical coupling module 10 that is mounted on a substrate 70. As shown in FIG. 10, the fixing member 80 includes a lower member 801 and an upper member 802.

The lower member 801 includes a fixing unit 801a that fixes the fixing member 80 to the substrate 70. The upper member 802 includes housing units 802a and 802b that house the mold unit 202 of the optical connector 20 and limit the movement of the optical connector 20. Further, the upper member 802 includes a locking mechanism 802c that fixes the lower member 801 and the upper member 802. The two housing units 802a and 802b are included for retaining together two optical connectors 20 that are used for transmission and receiving. However, only one housing unit is needed when using the single optical connector 20.

After connecting the optical connector 20 to the optical coupling module 10, the upper member 802 is moved such that the upper member 802 covers the mold unit 202 of the optical connector 20. As shown in FIG. 11, the upper member 802 is fixed by the locking mechanism 802c such that the movement of the optical connector 20 is restricted. Thus, the optical connector 20 is retained at the predetermined position and is less likely to be affected by the external force.

As shown in FIG. 12, when directly fixing the optical coupling module 10 to a chassis or housing 71 of the device that carries out optical communication without mounting the optical coupling module 10 on the substrate 70, the movement of the optical connector 20 can be restricted by using a fixing member 90 that includes a lower member 901 that is similar to the lower member 801 and an upper member 902 that is similar to the upper member 802. Further, the fixing member 90 can be fixed to the chassis 71 by using a fixing unit 901a of the lower member 901.

Thus, according to the third embodiment, the mold unit 202 of the optical connector 20 is fixed at the predetermined position by including a fixing member that restricts the movement of the optical connector 20. Thus, collapsing of the sleeve 102 and jolting of the ferrule 201, which occur due to inclination of the optical fiber on the side of the optical connector 20 along with the optical connector 20, can be restricted and the position of the coupling surfaces of the optical fibers can be retained according to the alignment function of the sleeve 102 even if the external force is applied.

According to an embodiment of the present invention, due to insertion of an optical connector, elastic members inside a guiding unit are deformed and fix the optical connector at a predetermined position. Thus, collapsing of a sleeve, which occurs due to inclination of an optical fiber on the optical connector side along with the optical connector, is restricted and a position of coupling surfaces of optical fibers can be retained according to an alignment function of the sleeve even if an external force is applied. Thus, communication quality can be enhanced.

According an embodiment of the present invention, a structure which deforms at the time of insertion of the optical connector and fixes the optical connector at the predetermined position is included in the optical connector. Thus, collapsing of the sleeve, which occurs due to inclination of the optical fiber on the optical connector side along with the optical connector, is restricted and the position of the coupling surfaces of the optical fibers can be retained according to the alignment function of the sleeve even if the external force is applied. Thus, communication quality can be enhanced.

According to an embodiment of the present invention, a fixing member which restricts a movement of the optical connector is included to fix the optical connector at the predetermined position. Thus, collapsing of the sleeve, which occurs due to inclination of the optical fiber on the optical connector side along with the optical connector, is restricted and the position of the coupling surfaces of the optical fibers can be retained according to the alignment function of the sleeve even if the external force is applied. Thus, communication quality can be enhanced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical coupling module that attaches and detaches an optical fiber supported by an optical connector with respect to an optical communication device, comprising:
a sleeve for receiving the optical fiber therein;
a sleeve case for covering the sleeve;
a guiding unit for guiding the optical connector such that the optical fiber, exposed at a tip of the optical connector, penetrates inside the sleeve when the optical connector is inserted from outside; and
an elastic member, provided on the guiding unit and capable of being deformed, for fixing the optical connector when the optical connector is inserted into the guiding unit.

2. An optical connector that supports a first optical fiber and is guided by a guiding unit mounted on an optical coupling module that couples the first optical fiber, exposed at a tip of the optical connector, with a second optical fiber attached to the optical coupling module, wherein
the optical connector includes a fixing structure that is deformed and fixed to the guiding unit when the optical connector is inserted into the guiding unit.

3. An optical coupling module that attaches and detaches an optical fiber supported by an optical connector with respect to an optical communication device, comprising:
a sleeve for receiving the optical fiber therein;
a sleeve case for covering the sleeve; and
a fixing member for restricting movement of the optical connector that causes the optical fiber, exposed at a tip of the optical connector, to penetrate the sleeve.

4. An auxiliary fixing member to be mounted on a substrate equipped with an optical coupling module that attaches an optical fiber supported by an optical connector with respect to the substrate, comprising:
a housing unit that restricts movement of the optical connector that causes the optical fiber, exposed at a tip of the optical connector, to penetrate the optical coupling module; and
a fixing unit that fixes the auxiliary fixing member to the substrate.

5. An auxiliary fixing member to be mounted on an optical communication device equipped with an optical coupling module that attaches an optical fiber supported by an optical connector with respect to the optical communication device, comprising:
a housing unit that restricts movement of the optical connector that causes the optical fiber, exposed at a tip of the optical connector, to penetrate the optical coupling module; and
a fixing unit that fixes the auxiliary fixing member to the optical communication device.
